(19) United States
(12) Patent Application Publication
(10) Pub. No.: US 2010/0018734 A1
(43) Pub. Date: Jan. 28, 2010

(54) ELECTRIC MACHINE TOOL

(76) Inventors: Karl Frauhammer, Leinfelden-Echterdingen (DE); Heinz Schnerring, Dettenhausen (DE); Willy Braun, Neustetten (DE); Axel Kuhnle, Freiberg (DE)

Correspondence Address: MICHAEL J. STRIKER, 103 EAST NECK ROAD, HUNTINGTON, NY, 11743, US

(21) Appl. No.: 11/573,588

(22) PCT Filed: Apr. 5, 2006
(86) PCT No.: PCT/EP2006/061344

§ 371 Date: Feb. 12, 2007

(30) Foreign Application Priority Data
May 11, 2005 (DE) 10 2005 021 731.1

(51) Int. Cl. B25D 17/00; H01H 3/04

(52) U.S. Cl. 173/171; 200/332

(57) ABSTRACT

The invention relates to an electric machine tool comprising a device body (10) that is disposed in a housing (11) and a handle (12) in which a switch (13) is arranged. Said switch (13) is indirectly connected to a switching element (14) located in the device body (10) in order to actuate an electric on/off switch (15).

### RELATED ART

The present invention is directed to a power tool according to the definition of the species in Claim 1.

The handling of power tools, rotary hammers in particular, is problematic in that the operator is exposed to relatively high levels of stress from vibratory forces, e.g., during hammering operation.

Power tools with vibration-dampening handles are known. In one design of a power tool, the handle is rotatably supported at its lower cantilever, and a small angular movement around the rotation point can be carried out. Vibrations are damped as a result, thereby making operation of the power tool more comfortable. The device is also easier to operate, thereby allowing it to be guided more safely. A problem with this design involves determining where to locate the electrical lines that lead to the on/off switch, which is usually located in the handle. The electrical leads should be located as close to the rotation point as possible so they are not slung outwardly, and to reduce the amount of relative travel between the device body and the handle. It is often difficult to realize this type of positioning, for design-related reasons.

In an alternative design, rotary hammers with a handle capable of being moved parallel to the impact direction are feasible. An optimal dampening of vibrations is attained as a result. The level of vibratory stress placed on the electrical lines leading to the on/off switch located on the handle is relatively high, however.

### ADVANTAGES OF THE INVENTION

With the inventive power tool, a switch located on the handle is indirectly connected with a switching element located in the device body for actuating an electrical on/off switch. Advantageously, an electrical switching function located in the device body and a mechanical switching function located in the handle are separated. Vibratory stress that acts on the electrical switching function is therefore advantageously reduced to a minimum. Advantageously, electrical safety is therefore ensured, above all. As a further advantage, no electrical leads to the mechanical switch in the handle are required, because they are replaced by the indirect connection according to the present invention. If the power tool is accidentally dropped or is exposed to other strong mechanical stresses, electrical safety is largely ensured with the inventive embodiment.

In a preferred embodiment of the present invention, the indirect connection is formed by a bowden cable. A wire cable, for example, is guided through a flexible plastic or metal sleeve, by way of which the tensile forces generated when the mechanical switch in the handle is actuated are advantageously transferable via curved paths to the electrical switching element in the device body.

To dampen the vibrations generated in drilling operation, the handle of the inventive power tool is designed to be movable relative to the housing, at least in the working direction. It can be provided that the handle is designed to be movable parallel to the impact direction. Another possible design is to mount the switch and/or the switching element such that they are pivotable around respective rotation points. A slight angular movement of components around the rotation point is therefore advantageously possible, thereby reducing the vibratory stress.

The switching element located in the device body is preferably designed as a lever with at least one upper lever arm and one lower lever arm. The bowden cable can be connected at its first free end with a lower lever of the mechanical switch in the handle. The mechanical switch is designed, e.g., as a toggle switch or a pawl. The bowden cable can be connected at its second free end with one of the lever arms of the switch element. When the mechanical switch is actuated, lever action of the lower lever arm of the mechanical switch is activated, and the lever action is transferred via the bowden cable to one of the lever arms of the switch element. Advantageously, the on/off switch is thereby activated automatically. If a potentiometer is connected with the on/off switch, it can be activated at the same time via the lever action described. With the potentiometer, an additional functionality—that is preferably designed as an acceleration functionality—can be realized.

When the mechanical switch is actuated via the bowden cable and via one of the lever arms of the switch element, a blocking function for a rotatable brush plate can be triggered. The rotatable brush plate serves to switch a rotational direction of the motor, e.g., from rotation in the right-hand direction to rotation in the left-hand direction. According to the present invention, when the motor is switched on, it is possible—by using a direct or indirect blocking function—to prevent the rotational direction of the motor from being switched during full-speed operation and thereby cause damage. With a direct blocking function, the brush plate can be rotated and/or its rotational direction reversed from the outside, in the region of a commutator. With an indirect blocking function, a reversal can be triggered in the region of the handle, preferably within a finger's reach, thereby resulting in a particularly user-friendly design of the switching function. With indirect blocking in particular, the blocking function can be triggered via one of the lever arms of the switch element and via a switching lever. The switching lever can be operated using a sliding element, which can be actuated for a drilling operation only when a rotary knob is in a defined position. In particular, the defined position of the rotary knob for the drilling mode can be attained via a flat region of the rotary knob. A user-friendly reversal of the directional rotation of the motor during full-speed operation can therefore be attained in a particularly simple manner, and, simultaneously, damage to the power tool caused by reversing the directional rotation of the motor during full-speed operation can be prevented.

The inventive embodiment is also feasible with a power tool with a rigid, fixedly attached handle, and with some chisel hammers, although it is not required that the rotational direction of the motor be switched.

### DRAWING

Further embodiments, aspects and advantages of the present invention also result independently of their wording in the claims, without limitation to generality, from exemplary embodiments of the present invention presented below with reference to the drawing.

FIG. 1 is a schematic illustration of a section through an embodiment of an inventive rotary hammer;

FIG. 2 is a schematic illustration of a section through an alternative embodiment of an inventive rotary hammer with an unactuated mechanical switch in the handle;

FIG. 3 is a depiction based on FIG. 2, with an actuated mechanical switch; and

FIG. 4 shows a top view of an inventive rotary hammer.

### DESCRIPTION OF THE EXEMPLARY EMBODIMENTS

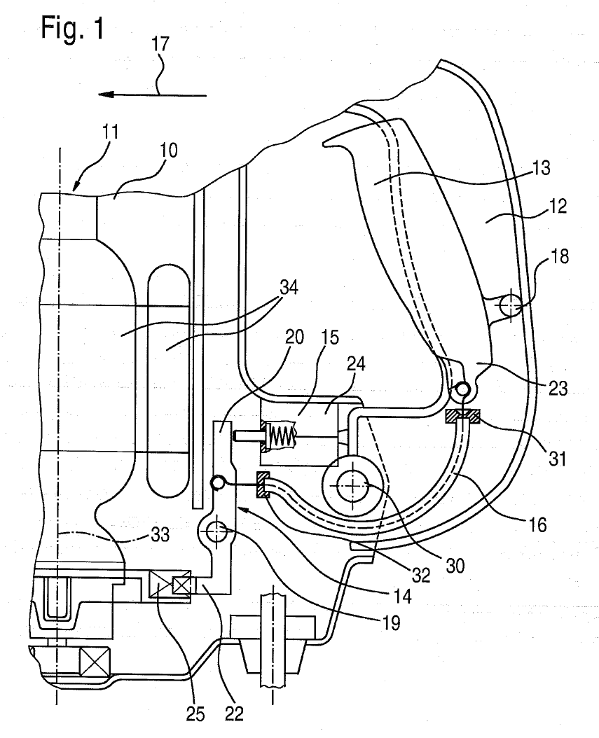

FIG. 1 shows a section through an inventive rotary hammer, in a schematic view. The rotary hammer includes a device body 10 located in a housing 11, and a handle 12. A motor 34 is located in device body 10. The rotational direction of motor 34 can be switched via a rotatable brush plate 25. It is therefore advantageously possible trigger a change in the rotational direction, as is used, e.g., to loosen screws. Handle 12 is designed to be movable relative to housing 11, at least in working direction 17. In particular, handle 12 is designed to be rotationally movable around a rotation point 30, by way of which a vibration-dampening function is fulfilled. A mechanical switch 13 designed as a pawl is located in handle 12. Pawl 13 is indirectly connected with a switching element 14 located in device body 10 for actuating an electrical on/off switch 15. A potentiometer 24 is integrated in on/off switch 15. Switching element 14 is designed as a lever with an upper lever arm 20 and a lower lever arm 22. An electrical switching function located in device body 10 and a mechanical switching function located in handle 12 are therefore separated by design, thereby minimizing the level of vibratory stress that acts on the electrical switching function. Switch 13 is mounted such that it can pivot around a rotation point 18, and switch element 14 is mounted such that it can pivot around a rotation point 19. As a result, the vibrations that act on the individual components during operation of the power tool are damped in an optimal manner.

The indirect connection between mechanical switch 13 and switch element 14 is formed by a bowden cable 16. The sleeve-like housing—which is preferably made of plastic—of bowden cable 16 bears at its free ends against stops 31, 32. Bowden cable 16 is connected at its first free end with a lower lever arm 23 of mechanical switch 13, and at its second free end with upper lever arm 20 of switch element 14.

Electrical on/off switch 15 and potentiometer 24 are activatable via the lever action between lower lever arm 23 of switch 13 and upper lever arm 20 of switch element 14. The mechanical advantage between mechanical switch 12 and switch element 14 is designed such that a contact gap of a few millimeters, e.g., fewer than 10 mm, oriented essentially opposite to working direction 17 results at on/off switch 15. Potentiometer 24 integrated in on/off switch 15 is provided as an acceleration function and is activated via corresponding actuation travel of mechanical switch 13. The more force applied to mechanical switch 13, the greater the activation of the acceleration function.

When switch 13 is actuated, lower lever arm 22 of switch element 14 is simultaneously moved via bowden cable 16 in working direction 17. Given the design with the mechanical advantages described above, lower lever arm 22 travels a lever path of a few millimeters. In particular, the lever path is shorter than contact gap of on/off switch 15. As a result, a direct blocking function for rotatable brush plate 25 is triggered. When mechanical switch 12 is actuated, rotation of brush plate 25 around motor axis 33 is blocked by lower lever arm 22 of switch element 14. Brush plate 25 is therefore unable to rotate when motor 34 is running. A change in rotational direction when motor 34 is switched on can therefore be advantageously prevented, thereby preventing serious damage to the power tool.

In the embodiment shown, the rotational direction of the motor can be switched by rotating brush plate 25 against a spring force using outwardly extending actuating ribs—which are not shown in FIG. 1—in the region of a commutator.

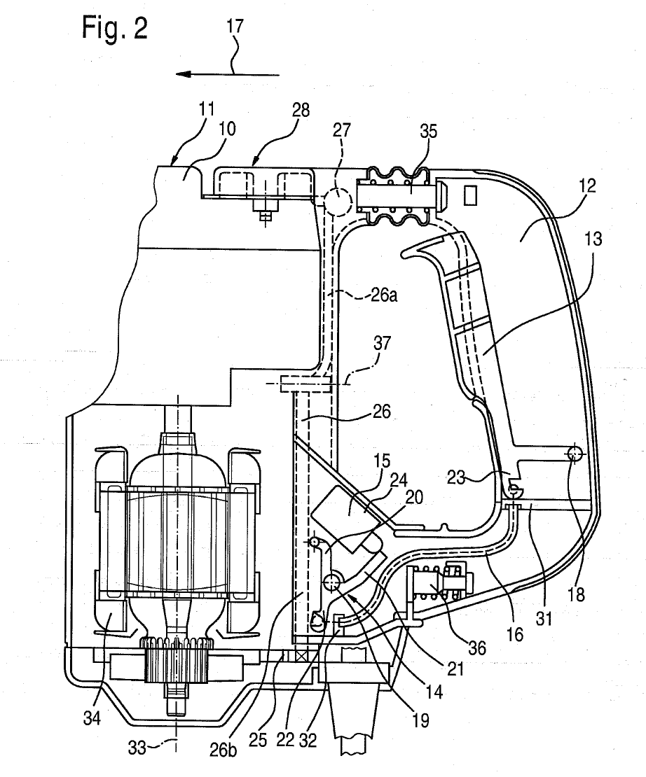

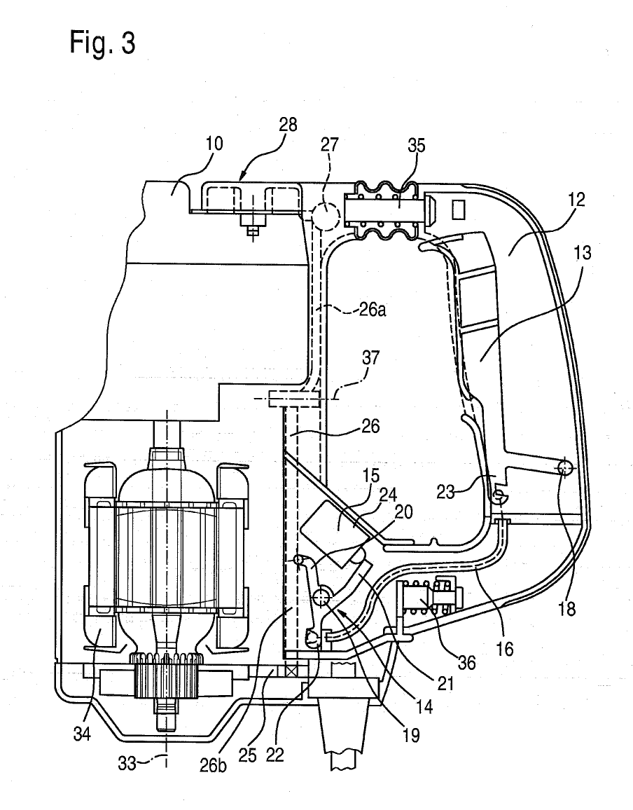

A section through an alternative embodiment of an inventive rotary hammer is shown in FIGS. 2 and 3. In both figures, a handle 12 is designed to be movable parallel to working direction 17. An upper guide 35 and a lower guide 36 are provided as the vibration-damping elements in an upper contact region and a lower contact region between handle 12 and device body 10. In FIG. 2, mechanical switch 13 in handle 12 is in a non-actuated state. In FIG. 3, switch 13 is actuated. The same elements have the same reference numerals in both figures.

As illustrated in FIG. 1, and with this embodiment as well, a flexible and vibration-resistant bowden cable 16 transfers a path covered by a pawl 13—that is mounted such that it can move around a rotation point 18—to lever arms 20, 21, 22 of a switch element 14 located in device body 10. Switch element 14 is designed as a lever with three lever arms 20, 21, 22 and is mounted such that it can move around a rotation point 19. As depicted in FIG. 1, bowden cable 16 bears via its housing against stops 31, 32. A free end of bowden cable 16 is connected with a lower lever arm 23 of pawl 13, and another free end is connected with lower lever arm 22 of switch element 14. When pawl 13 is actuated, i.e., when it is pressed opposite to working direction 17 (FIG. 2), lower lever arm 23 of pawl 13 moves in working direction 17, by way of which a tensile force acts on the wire-line enclosed in housing of bowden cable 16, which triggers a movement of lower lever arm 22 opposite to working direction 17. As a result, an electrical on/off switch 15 and an integrated potentiometer 24 are automatically activated via lever arm 21. The mechanical advantages of switch 13 and switch element 14 are designed such that a contact gap of a few millimeters, e.g., fewer than 10 mm, results at on/off switch 15.

When switch 13 is actuated, lever arm 20 is simultaneously moved via bowden cable 16 in working direction 17, by way of which a blocking function of rotatable brush plate 25 is triggered. In contrast to the blocking function described with reference to FIG. 1, the blocking function is not triggered directly in this case. Instead, it is triggered indirectly via a longitudinal switching lever 26. Switching lever 26 is mounted such that it can rotate around a rotational axis 37. Switching lever 26 is operated using a sliding element 27, which can be actuated for a drilling operation only when a rotary knob 28 is in a defined position. Using sliding element 27, an upper lever arm 26a of switching lever 26 is actuated. A lower lever arm 26b of switching lever 26 can rotate brush plate 25 around an angle, by way of which a change in rotational direction is introduced. When mechanical switch 13 is pressed or at least partially pressed, as illustrated in FIG. 3, a motor 34 is switched on. Due to the blocking effect, however, the rotational direction advantageously cannot be changed via brush plate 25 when motor 34 is switched on and, therefore, when the blocking function is activated by lever arm 20 of switch element 14.

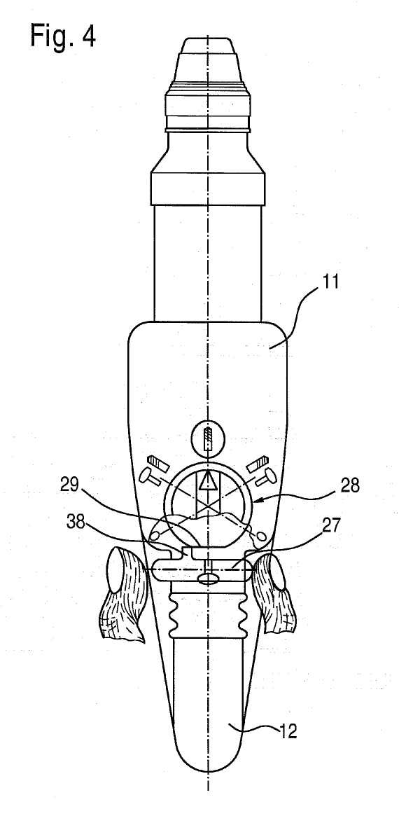

A top view of an inventive rotary hammer from above is shown in FIG. 4. Different operating modes can be selected using a mechanical rotary knob 28. An arrow is provided to indicate which operating mode has been selected. In FIG. 4, the arrow points to the pictogram of a screw thread, which represents a normal drilling mode. Various hammering modes can also be selected; the pictogram for them is a screw thread combined with a hammer. The aim is to switch the directional rotation of the motor only in a normal drilling mode without hammering, as indicated by the selection shown in FIG. 4. Switching lever 26, which is used to switch the rotational direction of the motor, and which is not shown in FIG. 4, is operated using a sliding element 27. Sliding element 27 can be operated only when rotary knob 28 is in a defined position for a drilling operation. The defined position is attained via a flat region 29 on rotary knob 28, the rest of which is round in design. In this position, sliding element 27 can be actuated and/or displaced axially from a left lock-in position into a right lock-in position. In this position, sliding element 27 can be easily actuated using two fingers. When rotary knob 28 is in any other position, sliding element 27 cannot be actuated, because this is prevented by a cantilever arm 38 of sliding element 27. Advantageously, a reversal of the rotational direction—e.g., from the right-hand direction to the left-hand direction—of the motor during hammering operation, which could result in serious damage to the power tool, is therefore easily prevented. The reversal of rotational direction is therefore particularly user-friendly in design.

What is claimed is:

1. A power tool with a device body (10) located in a housing (1), and a handle (12), in which a switch (13) is located,
wherein
the switch (13) is indirectly connected with a switch element (14) located in the device body (10) for actuating an electrical on-off switch (15).

2. The power tool as recited in claim 1,
wherein
the indirect connection is formed by a bowden cable (16).

3. The power tool as recited in claim 1,
wherein
the handle (12) is designed to be movable relative to the housing (11), at least in the working direction (17).

4. The power tool as recited in claim 1,
wherein
the switch (13) and/or the switch element (14) are installed such that they are pivotable around respective rotation points (18, 19).

5. The power tool as recited in claim 1,
wherein
the switch element (14) is designed as a lever with at least one upper lever arm (20) and one lower lever arm (22).

6. The power tool as recited in claim 5,
wherein
the bowden cable (16) is connected at its first end with a lower lever arm (23) of the switch (13), and it is connected at its second end with one of the lever arms (20, 21, 22) of the switch element (14).

7. The power tool as recited in claim 1,
wherein
the electrical on-off switch (15) is connected with a potentiometer (24).

8. The power tool as recited in claim 7,
wherein
the electrical on/off switch (15) and/or the potentiometer (24) are activatable via lever action between the lower lever arm (23) of the switch (13) and one of the lever arms (20, 21, 22) of the switch element (14).

9. The power tool as recited in claim 1,
wherein,
a blocking function for a rotatable brush plate (25) can be triggered via the bowden cable (16) and one of the lever arms (20, 21, 22) of the switch element (14) by actuating the switch (13).

10. The power tool as recited in claim 9,
wherein,
the blocking function can be triggered via one of the lever arms (20, 21, 22) of the switch element (14) and via a switching lever (26).

11. The power tool as recited in claim 10,
wherein
the switching lever (26) can be operated using a sliding element (27), and sliding element (27) can be actuated for a drilling mode only when a rotary knob (28) is in a defined position.

12. The power tool as recited in claim 11,
wherein
the defined position of the rotary knob (28) in the drilling mode can be attained via a flat region (29) on the rotary knob (28).
